(19) United States
(12) Patent Application Publication
(10) Pub. No.: US 2023/0121573 A1
(43) Pub. Date: Apr. 20, 2023

(54) BLOCKCHAIN-BASED SNEAKER AUTHENTICITY VERIFICATION AND TRACKING

(71) Applicant: Hypely, LLC, San Francisco, CA (US)

(72) Inventors: Eric Tuy, New York, NY (US); Brandon Quinn, San Francisco, CA (US); John Pena, Oakland, CA (US)

(21) Appl. No.: 17/966,645

(22) Filed: Oct. 14, 2022

Related U.S. Application Data
(60) Provisional application No. 63/255,844, filed on Oct. 14, 2021.

(51) Int. Cl. G06Q 30/00

(52) U.S. Cl. CPC G06Q 30/018

(57) ABSTRACT

Systems and methods are described providing blockchain-based footwear authentication and tracking. A server that includes a cryptographic blockchain database may receive and add to the blockchain a genesis block that includes both a feature vector, derived from a high-resolution photograph of a portion of a footwear item, and a low-resolution version of the high-resolution photograph. The server may subsequently receive a request for on-chain blocks referencing a first set of identifiers, including an identifier for the genesis block, from a verifier application. A comparison may be performed by the requesting application between the low-resolution version from the genesis block and a locally-captured photograph of a locally-possessed footwear item. If a match is detected, the application may receive an authentication input, which may cause a transaction block to be sent the server if the verification is part of a transfer of ownership of the locally-possessed footwear item.

### CROSS-REFERENCE TO RELATED APPLICATIONS

This application claims the benefit of U.S. Provisional Application No. 63/255,844, filed Oct. 14, 2021, which is incorporated herein in its entirety.

### TECHNICAL FIELD

Embodiments herein relate generally to decentralized network computing, and more specifically to using blockchain databases to establish secure tracking and verification of authenticity of digitally photographed footwear over network communications.

### SUMMARY OF THE INVENTION

Systems and methods are described providing blockchain-based footwear authentication and tracking. A server that includes a cryptographic blockchain database and which is a node of an associated blockchain network may receive a genesis block from a first verifier application over a network connection. The genesis block may include both a feature vector derived from a high-resolution photograph of a portion of a footwear item and a low-resolution version of the high-resolution photograph. The server may add the received genesis block to the blockchain database, assign an identifier to the genesis block, and associate ownership of the genesis block with a first user (e.g. the owner, manufacturer, or distributor of the footwear item). The server may subsequently receive a request by a second verifier application over the network connection for on-chain blocks referencing a first set of identifiers. For example, the second verifier may be in possession of the footwear item, and wish to verify its authenticity before a transfer of ownership. The verification process may include identifying genesis blocks on the blockchain database that are of the same model and vintage of the examined footwear item. These genesis blocks may be identified by performing a search of all identifiers having the user-specified features, which may result in identification of the first set of identifiers, where the first set of identifiers includes the identifier for the genesis block.

The server may then transmit the feature vector and the low-resolution version from the genesis block to the requesting application, possibly as part of a set of search results including information from a plurality of genesis blocks. A comparison may be performed using the second verifier application of the low-resolution version received over the network and a locally-captured high-resolution photograph of the locally-possessed footwear item. If a match is detected, the second verifier application may receive an authentication input, which may trigger transmission of a transaction block to the server if the verification is part of a transfer of ownership of the locally-possessed footwear item. The received transaction block may reference the genesis block, reflecting that the transfer is of the underlying footwear item. The server may then add the transaction block to the blockchain database, the adding including an on-chain transfer ownership of the genesis block to a second user.

### BRIEF DESCRIPTION OF THE FIGURES

This disclosure is illustrated by way of example and not limitation in the figures of the accompanying drawings, in which like references indicate similar elements, and in which:

FIG. 1 shows a simplified block diagram of a system for blockchain-based footwear authentication and tracking, according to an embodiment.

FIG. 2 shows a flow diagram for a method for blockchain-based footwear authentication and tracking, according to an embodiment.

FIG. 3 shows a flow diagram for a method of adding genesis and transaction blocks to a blockchain database, according to an embodiment.

FIG. 4 shows a simplified block diagram of a system generating and adding a genesis block to a blockchain database, according to an embodiment.

FIG. 5 shows a simplified block diagram of a system authenticating a footwear item based on a genesis block stored on a blockchain database, according to an embodiment.

FIG. 6 shows a simplified block diagram of a system authenticating a local footwear item and adding a transaction block to a blockchain database, according to an embodiment.

FIG. 7 shows a flow diagram for a method of an application generating and transmitting a genesis block to a blockchain database, according to an embodiment.

FIG. 8 shows a flow diagram for a method of authenticating a local footwear item and adding a transaction block to a blockchain database, according to an embodiment.

FIG. 9 shows an exemplary embodiment of an apparatus for capturing high-resolution images of a desired portion of a footwear item.

FIGS. 10A-B show simplified block diagrams of a chain of digital signatures of a plurality of transactions and a proof-of-work system, respectively, according to various embodiments.

FIG. 11 is a block diagram of an exemplary system for blockchain-based footwear authentication and tracking, according to an embodiment.

### DETAILED DESCRIPTION

Counterfeiting of luxury and athletic footwear, such as sneakers, remains a serious problem in the footwear industry. There are no conventional solutions that are reliable, leverage current technological improvements, and are compatible with existing footwear items without modification that may reduce the desirability of collectible footwear items. In addition to lost revenue and consumer trust, hazardous materials/chemicals used to manufacture fake products are dangerous to the consumer and may further implicate brands behind the footwear items.

To address these and other problems of conventional solutions, solutions described herein securely create unique identifiers on physical products, such as leather sneakers, that can be stored and retrieved from a blockchain database to later authenticate physical objects in real time. Unique identifiers may be captured on finished goods that can be used to derive a genesis block for a series of blockchain transactions. The identifiers may be processed, uploaded, and securely stored in distributed database systems that can be transacted using the blockchain. Using the same capture specifications to capture the identifier for the genesis block, authentication of local footwear items may be used to validate the authenticity of the local item and/or to transact the local item so that proof of authentication may seamlessly be transacted with the footwear item.

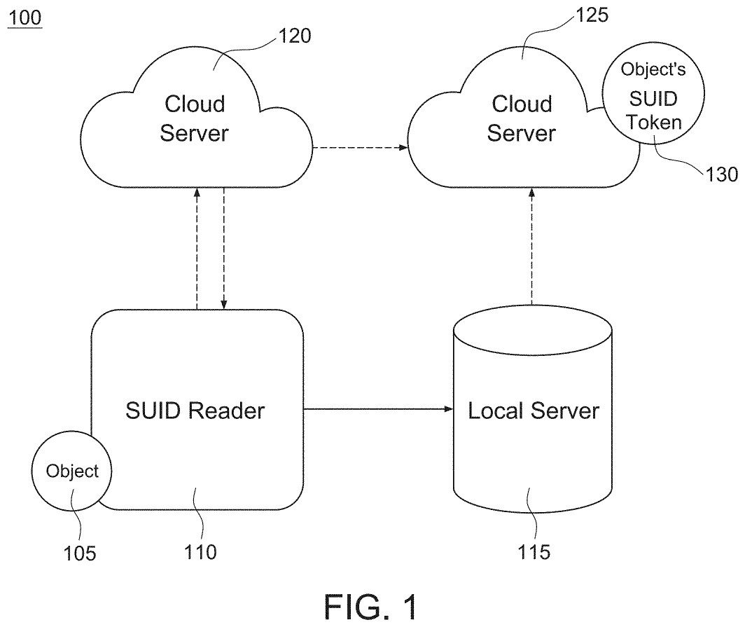

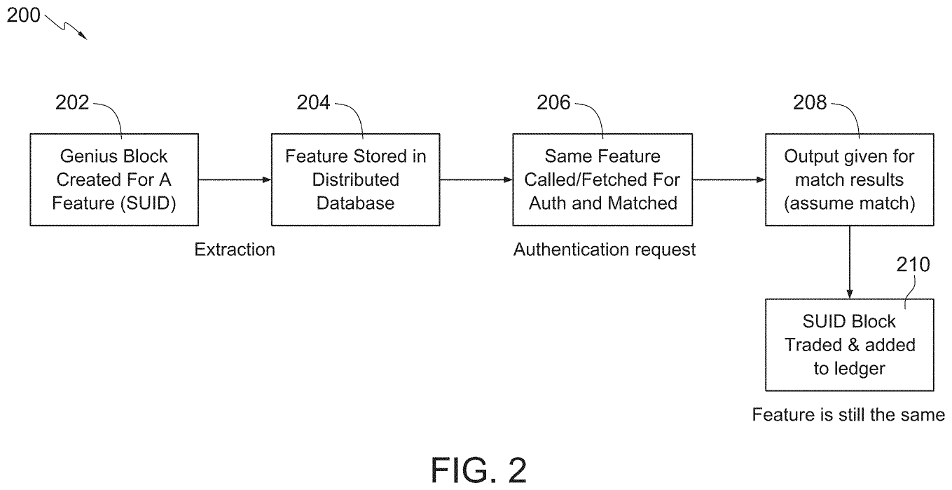

FIG. 1 shows a simplified block diagram of a system 100 for blockchain-based footwear authentication and tracking, according to an embodiment. FIG. 2 shows a high-level flow diagram for a method 200 for blockchain-based footwear authentication and tracking, according to an embodiment. The shoe unique identifier (SUID) reader 110 may be used to capture a unique identifier for a footwear item 105 by leveraging a microscopic camera at a zoom close enough to create a fingerprint image on a designated target zone. This image may be stored locally on the server 115 (i.e. a computing device—e.g. phone, computer, tablet) and processed to a distributed cloud based database 125, which may allow for offline validation by server 115. The SUID token 130 may be processed to create the storage block at step 202, and be stored as a genesis block on the blockchain database at step 204 of the method 200. In some embodiments, the ability to create genesis blocks for footwear may be limited to administrative users, while verification may be performed by a larger subset of users. The administrative identity may be logged on the genesis block, using personal signature details, which may add trust and transparency to the creation of the genesis block.

At step 206, the feature from the genesis block is retrieved from the genesis block stored on the blockchain database for authentication of a local footwear item by determining if a unique identifier captured from the local footwear item matches a unique identifier from any one of a first set of genesis blocks associated with a first set of identifiers. The authentication process may leverage the same specifications (camera and CPU) used to capture the high-resolution images used for the creation of the genesis blocks. Several different validation methods may be used, and are displayed in system 100. First, real time matching may be implemented where local server 115 has the local SUID fingerprint for the genesis blocks, and runs a matching algorithm to validate that the image of the object 105 matches an image associated with one of the genesis blocks on-site. A second real time matching implementation may be where the SUID reader 110 makes a call to the cloud server 120 (one of the nodes of the blockchain distributed database) to retrieve the SUID unique identifiers from the genesis blocks, and then runs the matching algorithm via local server 115 to validate that the image of the object 105 matches an image associated with one of the genesis blocks on-site. A third matching implementation may utilize offline matching, where the SUID unique identifiers are not locally stored by local server 115, and cannot be located from server 120 in real time. To perform matching, the image of the local object at question 105 is stored locally at local server 115, and batch processing is used when available to obtain the SUID unique identifiers from cloud server 125 (another node of the blockchain distributed database). Once the batch of the SUID unique identifiers is obtained, the matching algorithm may be executed to validate the image of the object 105.

Returning to method 200, once a match is found using any of the methodologies described above at block 208, a SUID transaction block may be generated and transmitted by the verifying application at block 210. The transaction block may be associated with the matching genesis block, as the feature described by the feature vector in the genesis block matches the local footwear item being transacted.

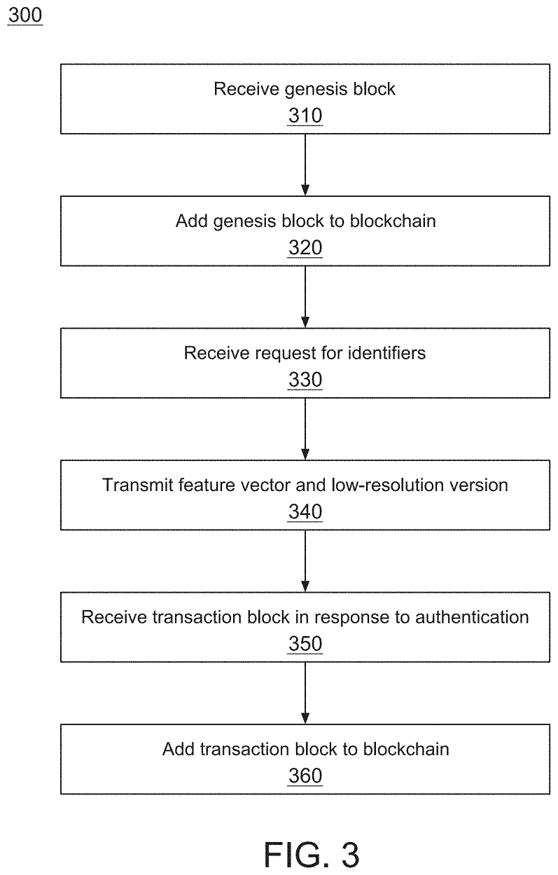

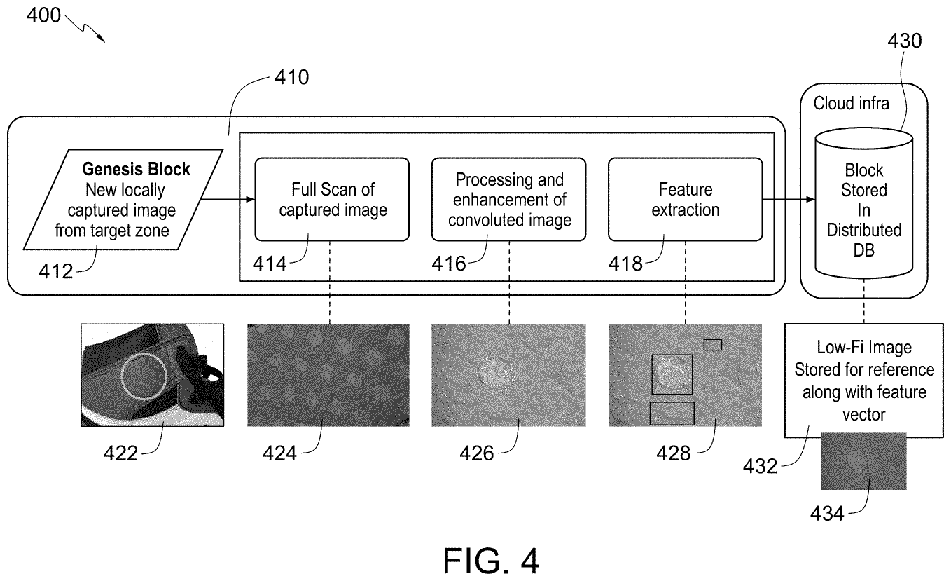

FIG. 3 shows a flow diagram for a method 300 of adding genesis and transaction blocks to a blockchain database, according to an embodiment. Method 300 may be a more detailed descriptions of steps 204 and 206 described above from the perspective of one of the cloud servers 120 and 125. A server that includes a cryptographic blockchain database and which is a node of an associated blockchain network may receive a genesis block from a first verifier application over a network connection at step 310. The genesis block may include both a feature vector derived from a high-resolution photograph of a portion of a footwear item and a low-resolution version of the high-resolution photograph. The creation and transmission of the genesis block is displayed in FIG. 4.

FIG. 4 shows a simplified block diagram of a system 400 generating and adding a genesis block to a blockchain database, according to an embodiment. System 400 depicts processing steps performed both by the local first verifier application (together with the image capture device) 410 and by the cloud server 430. The genesis block is created by first capturing a high-resolution image from a predetermined target zone on the footwear item at block 412. Any suitable imaging settings may be used for the high-resolution image, including any zoom level above 15× magnification. In some embodiments, a digital microscope with 50×-1000× zoom capabilities may be used to capture the high-resolution image (which may be 1920×1080 or higher resolution). The digital microscope may be communicatively coupled to a CPU through Bluetooth®, Wi-Fi®, or wired (USB, lightning) connection. For creating the genesis block and a “proof of stake” to have consensus amongst systems, the protocol of identifying the capture zone may be the source of truth. The location of the capture zone may have predetermined dimensions (such as a one inch by one inch square, or a circle having a ¼ of an inch diameter, for example) and position on footwear items, and may be selected to last over time to minimize degradation due to wear and tear on the footwear item. In the exemplary image 422 shown, the inner lace flap (circled in diagram 422) was selected as the capture zone, as the upper inner area of most footwear will have less wear than other areas. In some embodiments, the first verifier application may provide augmented reality overlays to assist a user in capturing the correct area for the footwear item with the microscope.

At block 414 the high-resolution image 424 is captured using the microscope camera. The light omitted by the camera may create depth in the texture of the footwear item, where deeper crevices create darker patterns, and bumpy texture reflects the light quicker and more brightly. The unique patterns from the target capture zoom may be parsed into binary code to create a unique identifier for the footwear item at block 416. Image 426 depicts an image from the capture zone of the same footwear item shown in image 422 having a higher amount of zoom than the image 424. At block 418 the feature vector is created for the SUID and ready to be added to the blockchain database as part of the genesis block for the footwear item shown in image 422. The unique features, highlighted in image 428, are selected (e.g., by the user capturing the image) and extracted from the bitstream created as a hash in block for a more compact representation of the high-resolution image captured in image 426.

At step 320 of method 300, the server may add the received genesis block to the blockchain database, assign an identifier to the genesis block, and associate ownership of the genesis block with a first user (e.g. the owner, manufacturer, or distributor of the footwear item). This is shown in system 400 as the block is stored in the distributed database 430. As described in block 432, the feature vector derived from the highlighted features shown in image 428 is stored in the block as a message, along with low-resolution version 434 of the high-resolution image 426.

The server may subsequently receive at step 330 a request by a second verifier application over the network connection for on-chain blocks referencing a first set of identifiers. For example, the second verifier may be in possession of the footwear item, and wish to verify its authenticity before a transfer of ownership. The verification process may include identifying genesis blocks on the blockchain database that are of the same model and vintage of the examined footwear item. These genesis blocks may be identified by performing a search of all identifiers having the user-specified features (such as using a fuzzy match or identical match of feature vectors associated with the shoe), which may result in identification of the first set of identifiers, where the first set of identifiers includes the identifier for the genesis block. Alternatively, the footwear may be associated with the SUID (using a NFC chip for example), where the NFC chip may be associated with an address for a web site that includes the SUID to securely allow the second verifier application to identify the genesis blocks associated with a piece of footwear.

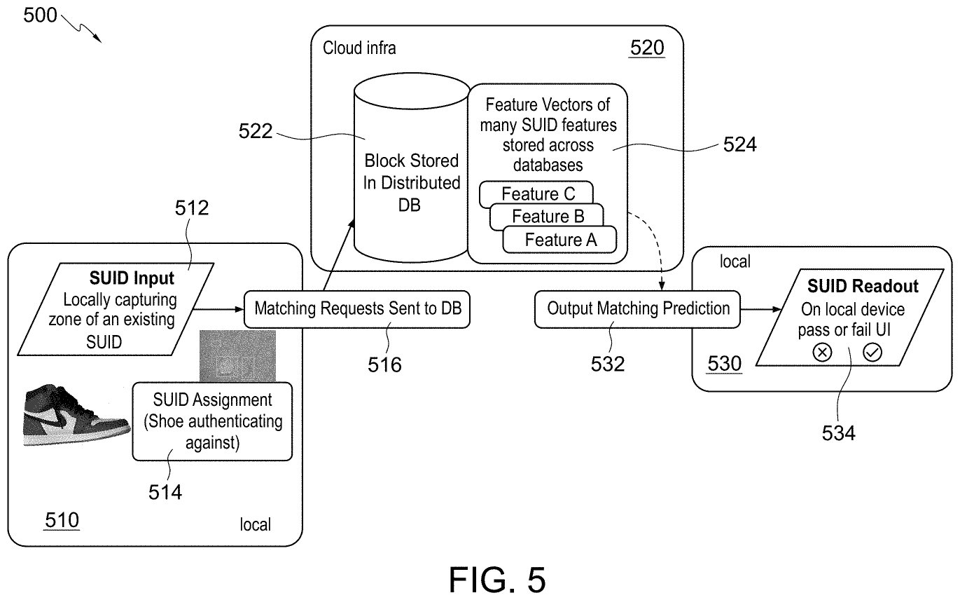

The server may then transmit the feature vector and the low-resolution version from the genesis block to the requesting application at step 340, possibly as part of a set of search results including information from a plurality of genesis blocks. A comparison may be performed using the second verifier application of the low-resolution version received over the network and a locally-captured high-resolution photograph of the locally-possessed footwear item. FIG. 5 shows a simplified block diagram of a system 500 authenticating a footwear item based on a genesis block stored on a blockchain database, according to an embodiment, elaborating further on steps 330-340 of method 300. Blocks 510 and 530 include processing steps taken by the second verifier application, in tandem with a local image capture device capturing a locally-possessed footwear item. Block 520 includes steps performed by the server that includes the blockchain database 522.

At block 512, the second verifier application uses the microscope camera to capture the high-resolution image of the capture zone of the local footwear item. Following the steps described above, a feature vector capturing the features of the local footwear item is generated at step 514, and validation events (for identifiers of footwear items that may match the local footwear item) are transmitted to the blockchain database 522 at step 516. Validation events may be sent in two ways: a) when the physical footwear is being validated against its own SUID on the blockchain database 522, and b) using a received SUID image of the footwear as a non-fungible token, where the second verifier application verifies the SUID image matches the SUID image on the blockchain database 522. When the physical footwear is being validated, by contrast, the desired comparison is between the microscopic image on the blockchain database 522 matching the same image taken of the physical footwear.

A response to the validation event may be transmitted by the blockchain database server, where the response 524 includes a plurality of feature vectors and low-resolution version associated with a plurality of genesis blocks. At block 534 the feature vectors from the genesis blocks are received by the second verifier application, which may provide an authentication input when one of the received feature vectors matches the feature vector 514 from the local footwear item. In some embodiments, the authentication input may be automatically generated as the result of a matching algorithm 532 being applied to the received feature vectors and the feature vector 514. The matching algorithm 532 may compute a degree of similarity between the feature vector 514 for the local footwear item and the received feature vectors 524. If the threshold of matching is greater than a predetermined threshold, the matching algorithm 532 may output the authentication input. However other methods of providing an authentication input may be utilized, including a user comparing an image associated with the genesis blocks manually with an image of the local footwear item. The image used for the comparison may be the low-resolution version stored with the genesis blocks, or a high-resolution image retrieved from an external database using an identifier associated with the genesis block (e.g. the feature vector itself).

If a match is not found between the feature vector of a local footwear item and the feature vectors within the retrieved genesis blocks, a no-match input may be provided, and authentication fails. If a match is detected in the comparison process, the second verifier application may receive an authentication input, which may trigger transmission of a transaction block to the server if the verification is part of a transfer of ownership of the locally-possessed footwear item at block 350 of method 300. The received transaction block may reference the genesis block, reflecting that the transfer is of the underlying footwear item. The server may then add the transaction block to the blockchain database, the adding including an on-chain transfer ownership of the genesis block to a second user at block 360.

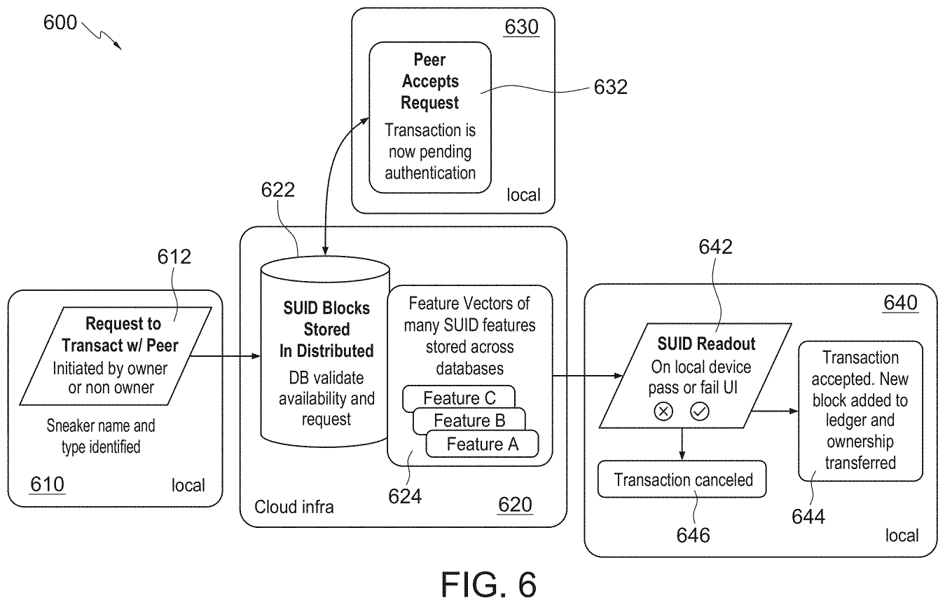

FIG. 6 shows a simplified block diagram of a system 600 authenticating a local footwear item and adding a transaction block to a blockchain database, according to an embodiment, elaborating further on steps 350-360 of method 300. Blocks 610 and 640 may be performed by the second verifier application, together with an image capture device. Block 630 may be performed by a user interested in acquiring the local footwear item. Block 620 may be performed by a server that acts as a node of the distributed blockchain database 622.

At block 612, a request to transact is issued by, for example, an owner of a local footwear item with the user wishing to acquire the local footwear item to the blockchain database 622. For example, a transaction block may be created pending authentication of the local footwear item by the owner of the local footwear item, using an automatically-executed smart contract associated with the transaction block. The user associated with application 630 may accept the request to transact at block 632 with an on-chain message for the transaction to proceed in accordance with the smart contract. If the user associated with application 630 denies the request to transact or does not respond within a predetermined time period specified by the smart contract, the request to transact may become null and no change of ownership of the SUID would take place. In response to receiving the on-chain transaction block, the blockchain database 622 may transmit the feature vectors associated with a plurality of genesis blocks associated with a footwear make and model included in the request to transact 612 to the second verifier application. As described above, authentication of the local footwear item may take place at block 642 based on comparing the received feature vectors of the genesis blocks 624 and the feature vector of the local footwear item. If no match is found, the transaction is canceled at block 646. If a match is found, then at block 644 a transaction block is added to the blockchain referencing the matching genesis block, and transferring ownership of the genesis block associated with the local footwear item to the user associated with application 630. In some embodiments, the transaction block may include an updated image of the footwear for use in future verification operations.

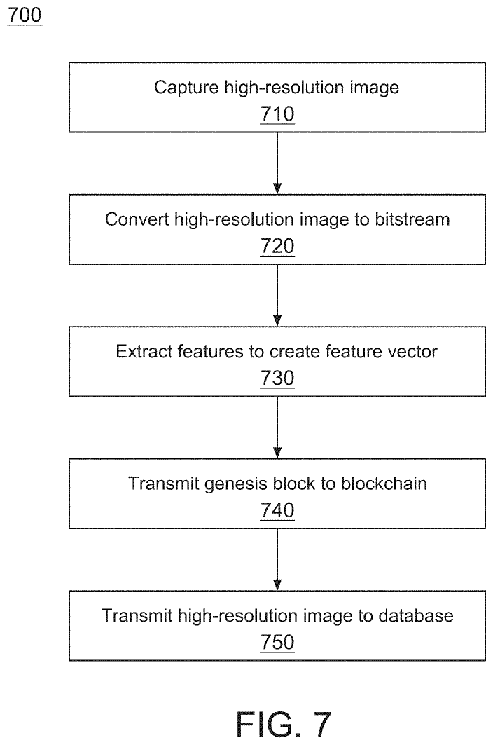

FIG. 7 shows a flow diagram for a method 700 of an application generating and transmitting a genesis block to a blockchain database, according to an embodiment. Method 700 details the steps taken by a verification application during genesis block generation, which an embodiment is shown in FIG. 4. At step 710, a high-resolution image is taken of a capture location of a local footwear item. This high-resolution image may be processed at step 720 to form a bitstream, from which features may be extracted that correspond to distinctive features seen in the high-resolution image at step 730 to create the feature vector associated with the local footwear item (also referred to herein as the “SUID”). In addition to image data, the bitstream may include additional metadata regarding the footwear, including original purchase or manufacturing data, stock keeping unit numbers, and model data, for example. The feature vector, together with a low-resolution version of the high-resolution image may be packaged together in a genesis block data structure, which may be transmitted to the blockchain at step 740. Finally, at block 750 the high-resolution image of the local footwear item may be transmitted to an external database.

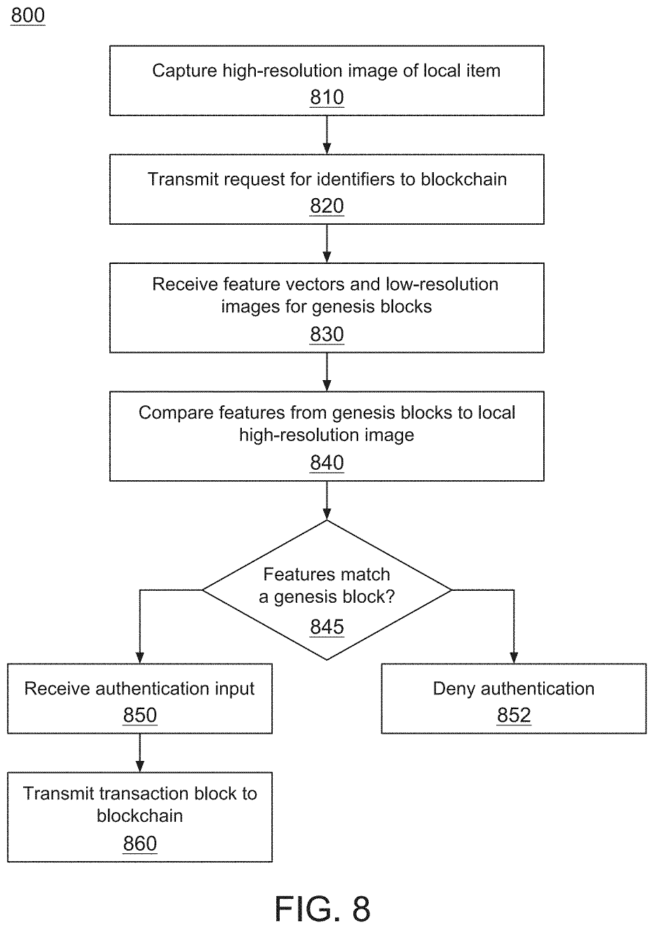

FIG. 8 shows a flow diagram for a method of authenticating a local footwear item and adding a transaction block to a blockchain database, according to an embodiment. Method 800 details the steps taken by a verification application during transaction of a footwear item associated with a genesis block, which an embodiment is shown in FIG. 6. After the two parties agree to a transaction of a local footwear item, authenticity may be verified by first capturing a high-resolution image of the local footwear item at step 810. At step 820, the verifier application may request genesis blocks associated with an identifier, such as the make and year of the footwear item, to a server storing a node of the blockchain database. In response to the request, feature vectors and low-resolution images for genesis blocks having the identifier may be received by the verifier application at step 830. The features may be compared to a feature vector derived from the local high-resolution image at step 840 to determine if any of the feature vectors on the blockchain database match the feature vector derived from the local footwear item at decision block 845. If no match is found, authentication is denied at block 852, and no transaction block will be generated. If a match is found, at block 850 an authentication input is received by the verifier application. The verifier application may then generate a transaction block and transmit the generated block at step 860.

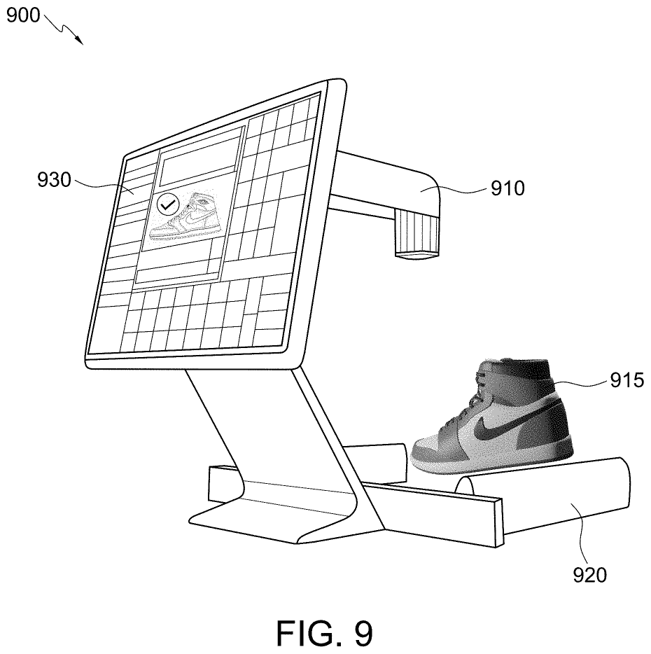

FIG. 9 shows an exemplary embodiment of an apparatus 900 for capturing high-resolution images of a desired portion of a footwear item. The apparatus 900 may be used with a verifier application by footwear manufacturers to track individual sales, or by customers in secondary sales. Apparatus 900 may include microscopic camera 910, which may be shaped to capture images of the proper dimensions of the local footwear item 915. Apparatus 900 may also include adjustable bracket 920 to accommodate footwear items of varying sizes, and computing device 930 to allow users to control the image capture process and communication with other devices. The verifier application may be executed on the computing device 930 directly, or by a user computing device in communication with the computing device 930.

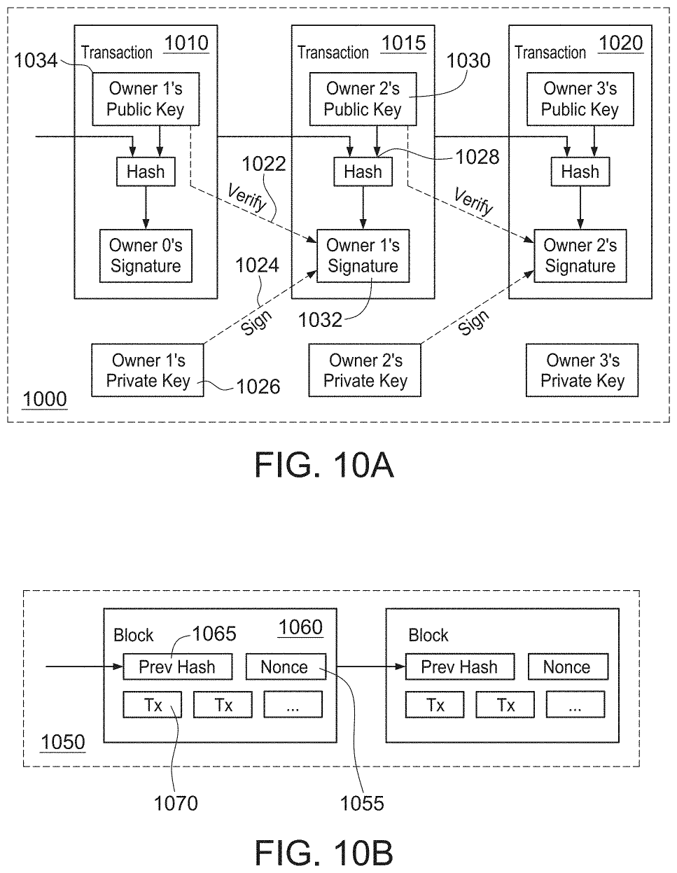

To further elaborate the use of on-chain messages described above, FIGS. 10A-B show simplified block diagrams of a chain of digital signatures 1000 of a plurality of transactions and a proof-of-work system 1050, respectively, according to various embodiments. In the digital signature chain 1000, each owner transfers amounts of the assets to the next owner by digitally signing a hash of the previous transaction involving the assets and the public key of the next owner, and adding these to the end of each asset. A payee can verify the transferred signatures to verify the chain of ownership, thus showing the asset to be legitimate. For example, in transaction 1015, the transferring owner, Owner 1, digitally signs hash 1028 of previous transaction 1010 involving the transferred asset and the public key 1030 of Owner 2, the recipient of the asset, to produce a signature for Owner 2 1032 at step 1024. To perform the step of verifying the signature, Owner 2 may use Owner 1's public key 1034 at verification step 1022. Subsequent transaction 1020 may be implemented in the same fashion as transaction 1015.

To assist in making sure a previous owner of an asset did not transact the same asset twice, a proof of work system 1050 may be implemented on each block in a ledger. For an exemplary timestamp scheme, the proof-of-work may be implementing by incrementing a nonce (number used once, a conventional cryptographic concept) 1055 in the block 1060 until a value is found that gives the block's previous hash 1065 the required zero bits initially recorded with the asset. As seen in system 1050 (implemented on a blockchain server, for example), each block 1060 also includes the first and second ring signatures, encrypted asset tag, and encrypted output amount 1070 stored on the blockchain ledger, as discussed above.

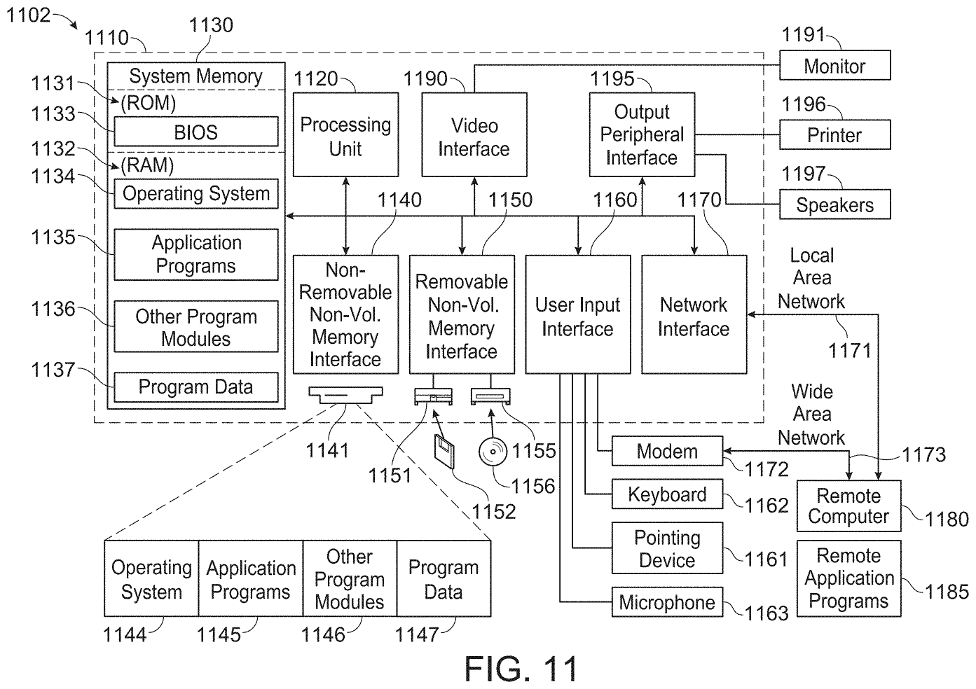

The methods and modules described above may be implemented using hardware or software running on a computing system. FIG. 11 is a diagram of an example computing system that may be used with some embodiments of the present invention. The computing system 1109 is only one example of a suitable computing system, such as a mobile computing system, and is not intended to suggest any limitation as to the scope of use or functionality of the design. Neither should the computing system 1109 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 1109 may be implemented as a mobile computing system such as one that is configured to run with an operating system (e.g., iOS) developed by Apple Inc. of Cupertino, Calif. or an operating system (e.g., Android) that is developed by Google Inc. of Mountain View, Calif.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 11, the computing system 1109 may include, but are not limited to, a processing unit 1120 having one or more processing cores, a system memory 1130, and a system bus 1121 that couples various system components including the system memory 1130 to the processing unit 1120. The system bus 1121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 1109 typically includes a variety of computer readable media. Computer readable media can be any available media that can be accessed by computing system 1109 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 1109. Communication media typically embodies computer readable instructions, data structures, or program modules.

The system memory 1130 may include computer storage media in the form of volatile and/or nonvolatile memory such as read only memory (ROM) 1131 and random access memory (RAM) 1132. A basic input/output system (BIOS) 1133, containing the basic routines that help to transfer information between elements within computing system 1109, such as during start-up, is typically stored in ROM 1131. RAM 1132 typically contains data and/or program modules that are immediately accessible to and/or presently being operated on by processing unit 1120. By way of example, and not limitation, FIG. 11 also illustrates operating system 1134, application programs 1135, other program modules 1136, and program data 1137.

The computing system 1109 may also include other removable/non-removable volatile/nonvolatile computer storage media. By way of example only, FIG. 11 also illustrates a hard disk drive 1141 that reads from or writes to non-removable, nonvolatile magnetic media, a magnetic disk drive 1151 that reads from or writes to a removable, nonvolatile magnetic disk 1152, and an optical disk drive 1155 that reads from or writes to a removable, nonvolatile optical disk 1156 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 1141 is typically connected to the system bus 1121 through a non-removable memory interface such as interface 1140, and magnetic disk drive 1151 and optical disk drive 1155 are typically connected to the system bus 1121 by a removable memory interface, such as interface 1150.

The drives and their associated computer storage media discussed above and illustrated in FIG. 11, provide storage of computer readable instructions, data structures, program modules and other data for the computing system 1109. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137. The operating system 1144, the application programs 1145, the other program modules 1146, and the program data 1147 are given different numeric identification here to illustrate that, at a minimum, they are different copies.

A user may enter commands and information into the computing system 1109 through input devices such as a keyboard 1162, a microphone 1163, and a pointing device 1161, such as a mouse, trackball or touchpad or touch screen. Other input devices (not shown) may include a joystick, gamepad, scanner, or the like. These and other input devices are often connected to the processing unit 1120 through a user input interface 1160 that is coupled with the system bus 1121, but may be connected by other interface and bus structures, such as a parallel port, game port or a universal serial bus (USB). A monitor 1191 or other type of display device is also connected to the system bus 1121 via an interface, such as a video interface 1190. In addition to the monitor, computers may also include other peripheral output devices such as speakers 1197 and printer 1196, which may be connected through an output peripheral interface 1190.

The computing system 1109 may operate in a networked environment using logical connections to one or more remote computers, such as a remote computer 1180. The remote computer 1180 may be a personal computer, a hand-held device, a server, a router, a network PC, a peer device or other common network node, and typically includes many or all of the elements described above relative to the computing system 1109. The logical connections depicted in FIG. 11 include a local area network (LAN) 1171 and a wide area network (WAN) 1173, but may also include other networks. Such networking environments are commonplace in offices, enterprise-wide computer networks, intranets and the Internet.

When used in a LAN networking environment, the computing system 1109 may be connected to the LAN 1171 through a network interface or adapter 1170. When used in a WAN networking environment, the computing system 1109 typically includes a modem 1172 or other means for establishing communications over the WAN 1173, such as the Internet. The modem 1172, which may be internal or external, may be connected to the system bus 1121 via the user-input interface 1160, or other appropriate mechanism. In a networked environment, program modules depicted relative to the computing system 1109, or portions thereof, may be stored in a remote memory storage device. By way of example, and not limitation, FIG. 11 illustrates remote application programs 1185 as residing on remote computer 1180. It will be appreciated that the network connections shown are exemplary and other means of establishing a communications link between the computers may be used.

It should be noted that some embodiments of the present invention may be carried out on a computing system such as that described with respect to FIG. 11. However, some embodiments of the present invention may be carried out on a server, a computer devoted to message handling, handheld devices, or on a distributed system in which different portions of the present design may be carried out on different parts of the distributed computing system.

Another device that may be coupled with the system bus 121 is a power supply such as a battery or a Direct Current (DC) power supply) and Alternating Current (AC) adapter circuit. The DC power supply may be a battery, a fuel cell, or similar DC power source that needs to be recharged on a periodic basis. The communication module (or modem) 172 may employ a Wireless Application Protocol (WAP) to establish a wireless communication channel. The communication module 172 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

In the description above, the subject matter may be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

For purposes of the present description, the terms “component,” “module,” and “process,” may be used interchangeably to refer to a processing unit that performs a particular function and that may be implemented through computer program code (software), digital or analog circuitry, computer firmware, or any combination thereof.

It should be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

In the description above and throughout, numerous specific details are set forth in order to provide a thorough understanding of the disclosure. It will be evident, however, to one of ordinary skill in the art, that the disclosure may be practiced without these specific details. In other instances, well-known structures and devices are shown in block diagram form to facilitate explanation. The description of the preferred an embodiment is not intended to limit the scope of the claims appended hereto. Further, in the methods disclosed herein, various steps are disclosed illustrating some of the functions of the disclosure. One will appreciate that these steps are merely exemplary and are not meant to be limiting in any way. Other steps and functions may be contemplated without departing from this disclosure.

What is claimed is:

1. A method for blockchain-based footwear authentication and tracking, the method comprising:
receiving, by a server that includes a cryptographic blockchain database and is a node of an associated blockchain network, a genesis block from a first verifier application over a network connection, the genesis block comprising both a feature vector derived from a high-resolution photograph of a portion of a footwear item and a low-resolution version of the high-resolution photograph;
adding, by the server, the genesis block to the blockchain database, the adding comprising assigning an identifier to the genesis block and associating ownership of the genesis block with a first user;
receiving, by the server, a request by a second verifier application over the network connection for on-chain blocks referencing a first set of identifiers, the first set of identifiers comprising the identifier for the genesis block;
transmitting, by the server, the feature vector and the low-resolution version from the genesis block to the requesting application;
receiving, by the server, a transaction block, the transaction block being transmitted by the second verifier application in response to an authentication input received by the second verifier application; and
adding the transaction block to the blockchain database, the transaction block referencing the genesis block and transferring ownership of the genesis block to a second user.

2. The method of claim 1, the blockchain database comprising a plurality of other genesis blocks, each genesis block being associated with a different item of footwear, where each feature vector of the genesis blocks is uniquely associated with a single pair of footwear items.

3. The method of claim 2, where each of the genesis blocks on the blockchain database is associated with the same model of footwear.

4. The method of claim 1, the feature vector being derived from the high-resolution photograph of the portion of the footwear item by converting the high-resolution photograph into a bitstream, and converting the bitstream into a feature vector that distils the bitstream into a subset of values associated with distinctive features in the high-resolution photograph.

5. The method of claim 4, the high-resolution photograph being taken at least 50× magnification, the portion of the footwear item being selected from a plurality of areas for having less friction damage under normal use.

6. The method of claim 1, the authentication input being received by the verifier application in response to comparing the low-resolution version received over the network with a locally-captured high-resolution photograph of a local footwear item, the authentication input being an indication that the locally-captured high-resolution photograph matches the low-resolution version.

7. The method of claim 6, further comprising executing a matching process by the verifier application that compares a feature vector derived from the locally-captured high-resolution photograph with the feature vector of the genesis block, and providing the authentication input when the feature vector derived from the locally-captured high-resolution photograph matches the feature vector of the genesis block within a predetermined similarity threshold.

8. The method of claim 1, the high-resolution photograph of the portion of the footwear item being stored remotely on a separate database, the method further comprising the second verifier application using the genesis block to receive, via a network connection, the high-resolution photograph of the portion of the footwear item being used to generate the authentication input received by the second verifier application.

9. A computer program product comprising computer-readable program code to be executed by one or more processors when retrieved from a non-transitory computer-readable medium, the one or more processors operating on a server that includes a cryptographic blockchain database that is also a node of an associated blockchain network, the program code including instructions to:
receive a genesis block from a first verifier application over a network connection, the genesis block comprising both a feature vector derived from a high-resolution photograph of a portion of a footwear item and a low-resolution version of the high-resolution photograph;
add the genesis block to the blockchain database, the adding comprising assigning an identifier to the genesis block and associating ownership of the genesis block with a first user;
receive a request by a second verifier application over the network connection for on-chain blocks referencing a first set of identifiers, the first set of identifiers comprising the identifier for the genesis block;
transmit the feature vector and the low-resolution version from the genesis block to the requesting application;
receive a transaction block, the transaction block being transmitted by the second verifier application in response to an authentication input received by the second verifier application; and
add the transaction block to the blockchain database, the transaction block referencing the genesis block and transferring ownership of the genesis block to a second user.

10. The computer program product of claim 9, the blockchain database comprising a plurality of other genesis blocks, each genesis block being associated with a different item of footwear, where each feature vector of the genesis blocks is uniquely associated with a single pair of footwear items.

11. The computer program product of claim 10, where each of the genesis blocks on the blockchain database is associated with the same model of footwear

12. The computer program product of claim 9, the feature vector being derived from the high-resolution photograph of the portion of the footwear item by converting the high-resolution photograph into a bitstream, and converting the bitstream into a feature vector that distils the bitstream into a subset of values associated with distinctive features in the high-resolution photograph.

13. The computer program product of claim 12, the high-resolution photograph being taken at least 50× magnification, the portion of the footwear item being selected from a plurality of areas for having less friction damage under normal use.

14. The computer program product of claim 9, the authentication input being received by the verifier application in response to comparing the low-resolution version received over the network with a locally-captured high-resolution photograph of a local footwear item, the authentication input being an indication that the locally-captured high-resolution photograph matches the low-resolution version.

15. The computer program product of claim 14, the program code further including instructions to execute a matching process by the verifier application that compares a feature vector derived from the locally-captured high-resolution photograph with the feature vector of the genesis block, and provide the authentication input when the feature vector derived from the locally-captured high-resolution photograph matches the feature vector of the genesis block within a predetermined similarity threshold.

16. The computer program product of claim 9, the high-resolution photograph of the portion of the footwear item being stored remotely on a separate database, the method further comprising the second verifier application using the genesis block to receive, via a network connection, the high-resolution photograph of the portion of the footwear item being used to generate the authentication input received by the second verifier application.

17. A system for blockchain-based footwear authentication and tracking comprising:
one or more processors; and
a non-transitory computer readable medium storing a plurality of instructions, which when executed, cause the one or more processors to:
receive a genesis block from a first verifier application over a network connection, the genesis block comprising both a feature vector derived from a high-resolution photograph of a portion of a footwear item and a low-resolution version of the high-resolution photograph;
add the genesis block to the blockchain database, the adding comprising assigning an identifier to the genesis block and associating ownership of the genesis block with a first user;
receive a request by a second verifier application over the network connection for on-chain blocks referencing a first set of identifiers, the first set of identifiers comprising the identifier for the genesis block;
transmit the feature vector and the low-resolution version from the genesis block to the requesting application;
receive a transaction block, the transaction block being transmitted by the second verifier application in response to an authentication input received by the second verifier application; and
add the transaction block to the blockchain database, the transaction block referencing the genesis block and transferring ownership of the genesis block to a second user.

18. The system of claim 17, the blockchain database comprising a plurality of other genesis blocks, each genesis block being associated with a different item of footwear, where each feature vector of the genesis blocks is uniquely associated with a single pair of footwear items and each of the genesis blocks on the blockchain database is associated with the same model of footwear.

19. The system of claim 17, the feature vector being derived from the high-resolution photograph of the portion of the footwear item by converting the high-resolution photograph into a bitstream, and converting the bitstream into a feature vector that distils the bitstream into a subset of values associated with distinctive features in the high-resolution photograph, the high-resolution photograph being taken at least 50× magnification, the portion of the footwear item being selected from a plurality of areas for having less friction damage under normal use.

20. The system of claim 19, the authentication input being received by the verifier application in response to comparing the low-resolution version received over the network with a locally-captured high-resolution photograph of a local footwear item, the authentication input being an indication that the locally-captured high-resolution photograph matches the low-resolution version.
